(19) United States
(12) Patent Application Publication
(10) Pub. No.: US 2012/0049988 A1
(43) Pub. Date: Mar. 1, 2012

(54) Binary continuous no-flux electricity brushless generator

(76) Inventor: Daniel Hans Johnson, Maple Ridge (CA)

(21) Appl. No.: 13/135,794

(22) Filed: Jul. 15, 2011

Related U.S. Application Data
(60) Provisional application No. 61/402,539, filed on Sep. 1, 2010.

(51) Int. Cl. H01F 3/00

(52) U.S. Cl. 335/256

(57) ABSTRACT

A Binary generator comprises a plurality of windings each being adapted to rotate between attracting magnetic fields generating current flow. The current flows through closed circuits to a multiple pole star electromagnet with all poles having similar torque exerting properties, both stages affixed to a common shaft and rotating in unison. The unidirectional flow of energy each half cycle relating to the magnets, not the wire, maintains a constant similar attitudes of sweeping fields of said poles to each half of an affixed coil of wire on the exterior of the rotating poles. Constant opposite striking of similar poles on each half of the coil induces a brushless current flow of energy that does not display a standard magnetic field around the conductor while the energy is in motion.

### FIELD OF THE INVENTION

This invention is a new concept in generating electricity from mechanical power without the use of brushes or contacts. Using a different approach to the universal power in a magnetic cell. Specifically this invention produces a continuous flow of energy through a conducting wire and does not display the standard surrounding magnetic field while the energy is in motion.

### BACKGROUND OF THE INVENTION

Many years of independently studying the structure of a magnetic cell and resulting forces on material objects from opposite halves of a cell lead to the development of the Continuous Direct Current Generator. Further studies and analysis of the magnetic cell and the search for a more efficient brushless method of producing electrical energy has taken the process one step further. Using a combination of opposed magnet generating, closed circuits, momentary solenoids and a free standing winding a continuous brushless flow of energy may be generated.

### SUMMARY OF THE INVENTION

The Binary brushless generator uses magnetic energy in two different ways simultaneously to create a continuous flow of energy in a wire conductor that does not display a standard magnetic field or flux around the wire. The binary system begins with a grooved core, windings on opposed notches rotating within opposed magnets forcing energy flow in the wire coil in the same direction each half cycle.

The leads from the core winding follow the common rotating shaft to a solenoid constructed at right angle to the common shaft and affixed to said shaft to turn in unison. The core winding and solenoid winding complete a single closed circuit, as the energy flow is generated in the core winding the electromagnet is also energized with the same directional attitude each half cycle. The generic magnet that is created each half cycle has similar poles at each end and similar torque inducing properties, a standard opposed magnet has two different poles and two different torque inducing properties.

A drum is assembled over the potentially rotating electro-magnet with collared openings at either end to accommodate the rotating shaft and primary-solenoid leads. The cage drum is affixed with two spacer blocks on opposite exterior surfaces 180 degrees apart parallel to shaft and occupying about 10 degrees of arc each. Alignment pins equal to the interior diameter of the housing are placed around the outside circumference at each end of the cage drum.

The cage winding is then applied to said drum with coils aligned with common shaft, each side of the coil are 180 degrees apart. The starting end has a free end, the turns progress around cage drum filling 170 degrees of arc on either side between alignment pins and end with a free length of lead. The three completed stages are the inserted into the metal housing containing opposed magnets for primary stage one, common shaft centered in bearings aligns stage one in opposed magnets and electromagnet in stage two. Alignment pins center cage drum and winding when inserted into housing. The projecting fields of the rotating solenoids pass through the cage winding coils at right angle inducing current flow in stage three.

Standard rules of motion, field and flow are a little different in the Binary system because there are two like poles causing the flow instead of two opposed poles with opposite torque inducing properties. A standard generator is opposite torque and opposite striking direction which is a plus-plus situation. Binary has similar torque and opposite striking direction making it a plus-minus combination causing a magnetically neutral flow of energy. All stages of the Binary generator are completed brushless and free of any contacts.

### BRIEF DESCRIPTION OF THE DRAWINGS

FIG. 1 Cut away view showing physical relationship from right side, primary generating core winding between opposed magnets to left side, electromagnets rotating within a stationary cage winding. Primary section and electromagnet are affixed to a central common shaft suspended at each end with bearings mounted in the housing showing no brushes or contacts between stages.

FIG. 2 A view of primary grooved core with typical windings in opposed notches not terminating at the ends, shown removed from housing and opposed magnets.

FIG. 3 A view of stage two electromagnet removed from cage winding drum that is removed from housing.

FIG. 4 Typical solenoid winding around one segment of star electromagnet showing moving field through stationary cage winding.

FIG. 5 Cage winding around cage drum illustrating centering and alignment pins and spacer blocks between opposing halves of cage winding.

FIG. 6 Typical view of alignment of primary winding in relation to solenoid coil of electromagnet.

FIG. 7 Showing lead from primary winding to second stage solenoid coil along central shaft and lead returning to primary electrically connected forming a closed circuit.

FIG. 8 End view of star electromagnet solenoid winding, 2 halves of cage winding, rotation, continuous field sweep areas, neutral position of half cycle where switching occurs in direction of flow in relation to the wire.

FIG. 9 A standard generating coil of wire shown in a straight line, illustrating a single turn of wire within opposed magnets, rotation of core showing striking direction and arrows on wire are the torque exerting forces from opposed magnets which demonstrate a continuous torque force on the wire.

FIG. 10 A Binary stationary generating coil of wire shown in a straight line illustrating a single turn of wire being swept by similar poles of a rotating electromagnet with opposite striking direction. Arrows on wire are the torque exerting forces from “like” poles which demonstrate a duel torque force simultaneously.

FIG. 11 Perspective flow diagram, brushless closed circuits between primary section 35 and solenoid winding 36 rotating in unison within stationary cage winding 37.

### DETAILED DESCRIPTION OF THE PREFERRED EMBODIMENT OF THE INVENTION

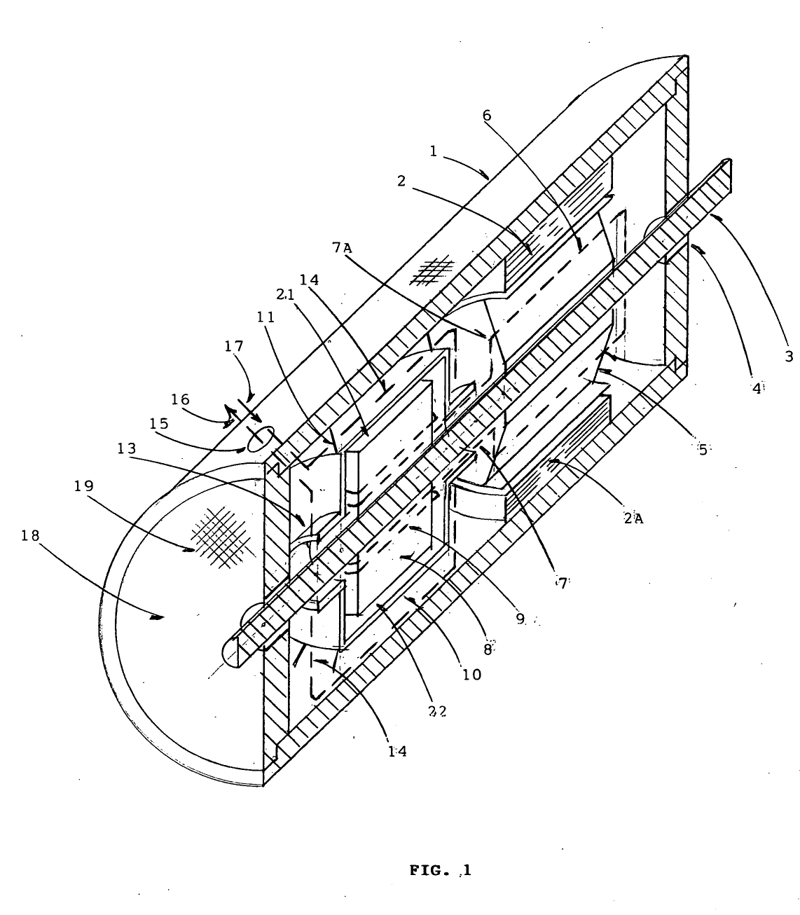

According to the preferred embodiment as shown in FIG. 1 the Binary system is enclosed in a cylindrical housing 1 which is an enclosure to support shaft 3 and all its rotating elements, primary stage one 35, solenoid stage two 36 and affixed cage winding section 37, also to support opposed magnets 2 and 2a. Also FIG. 1 shows housing 1 as the exterior support for cage drum 10 and cage winding 25 affixed to housing 1 bonding area 14. Housing 1 shall be constructed of magnetically conductive material with centrally positioned bearings 4 on both end caps 18 to support shaft 3. Said shaft 3 shall have a permanently, affixed primary core 5 and electro-magnet core 8 to rotate in unison.

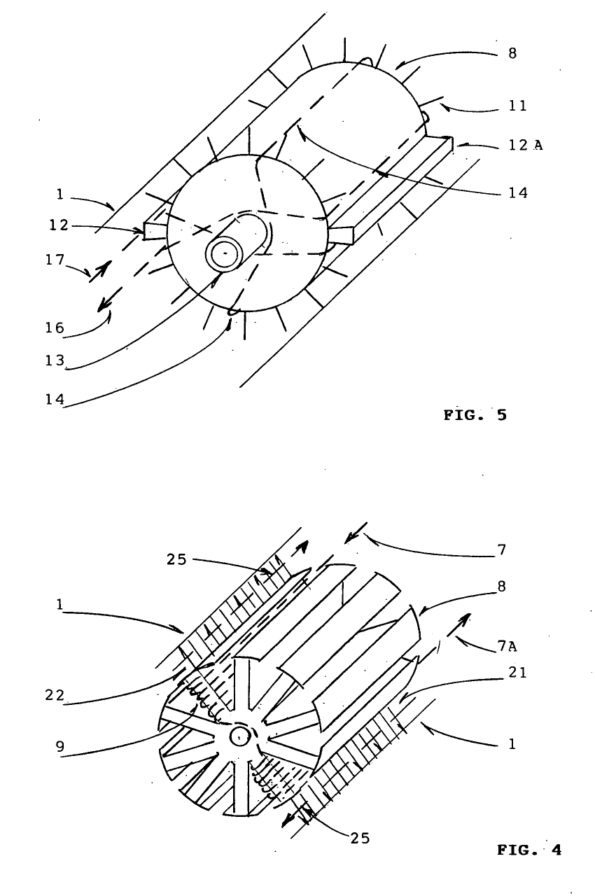

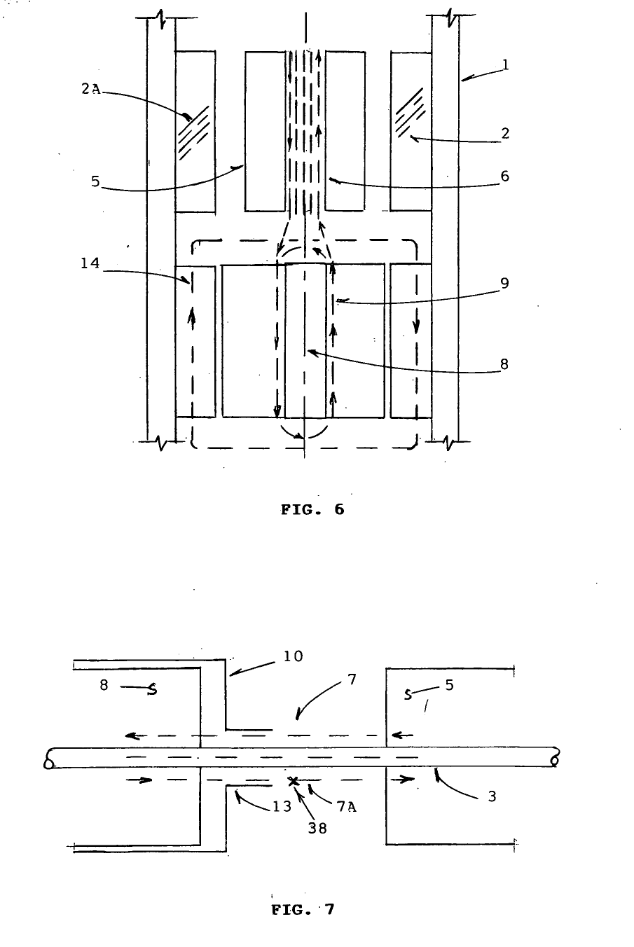

FIG. 6 demonstrates alignment between primary winding 6 and solenoid winding 9 maintained with all closed circuits that are to be used. Housing 1 shall be vented 19 where required and base mounted to fit application. Housing 1 shall be made of magnetically conductive material to complete the magnet cell of opposed magnets 2 and 2a and to act as receiver for rotating fields 21 and 22 in FIG. 4 and shown as field of sweep 24 in FIG. 8. Housing 1 as shown in FIG. 1 shall have an electrically insulated opening 15 for leads 16 and 17 from cage winding 25 that is bonded 14 to inner side of housing 1.

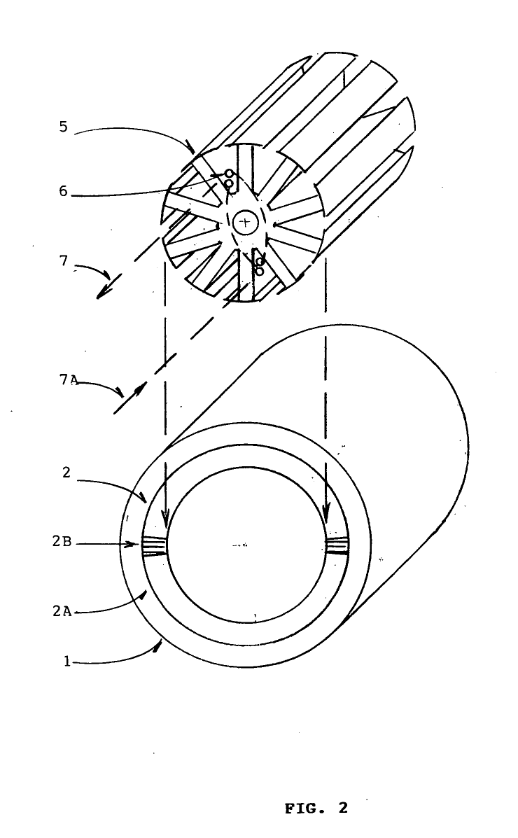

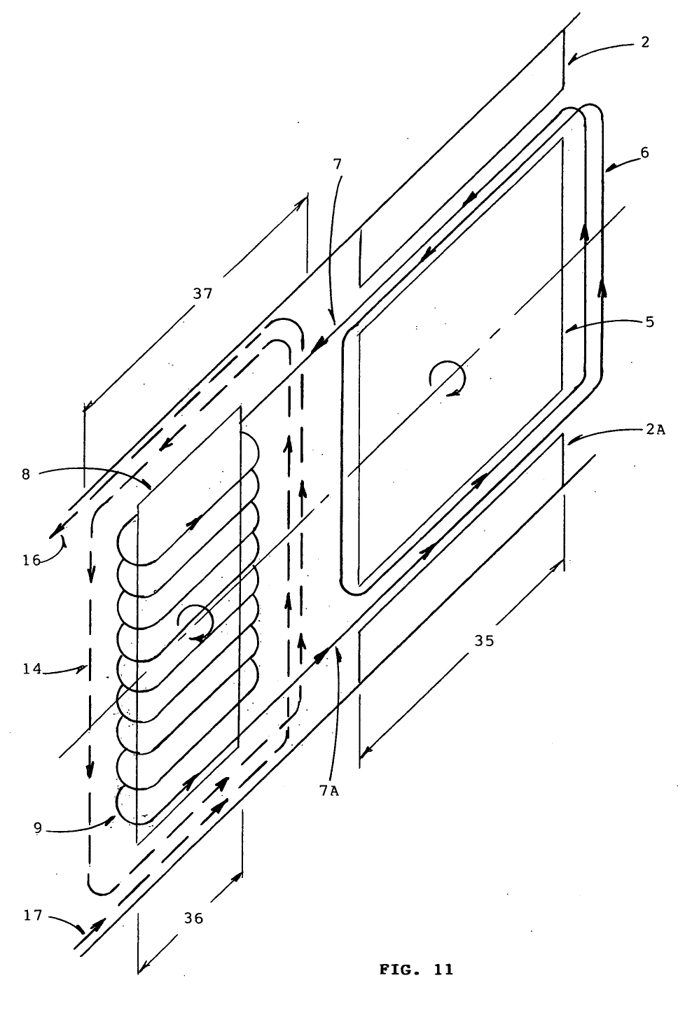

Sequence of windings found suitable in the test model shown in FIG. 1 and FIG. 2 illustrates primary winding 6 wound on core 5 in opposed grooves 180 degrees apart. The windings 6 are coiled in grooves on core 5 in parallel loops aligned with central shaft 3, wire size and number of turns to suit the situation. A working length approximately one turn length is left free at the start of winding 6 when it enters the coil around primary core 5 in the determined direction of flow using standard rules of field, motion and flow direction. The completion end of coil 6 is lead 7 which then runs parallel along shaft 3 over to stage two 36 entering directly into solenoid coil 9 as shown in FIG. 11.

As shown in FIG. 6 solenoid core 8 is directly in line with primary core 5 grooves. Viewing the solenoid core 8 end that is facing primary coil 6, the wire lead 7 enters the turns on the left side of the solenoid core 8 making right hand turns 9 around said core 8, when required turns are completed on one half 30 shown in FIG. 8 there is a cross over 27 around central shaft 3 to half 31 where an equal number of turns are applied in the same direction, in test model 50 turns 9 are applied to each half 30 and 31.

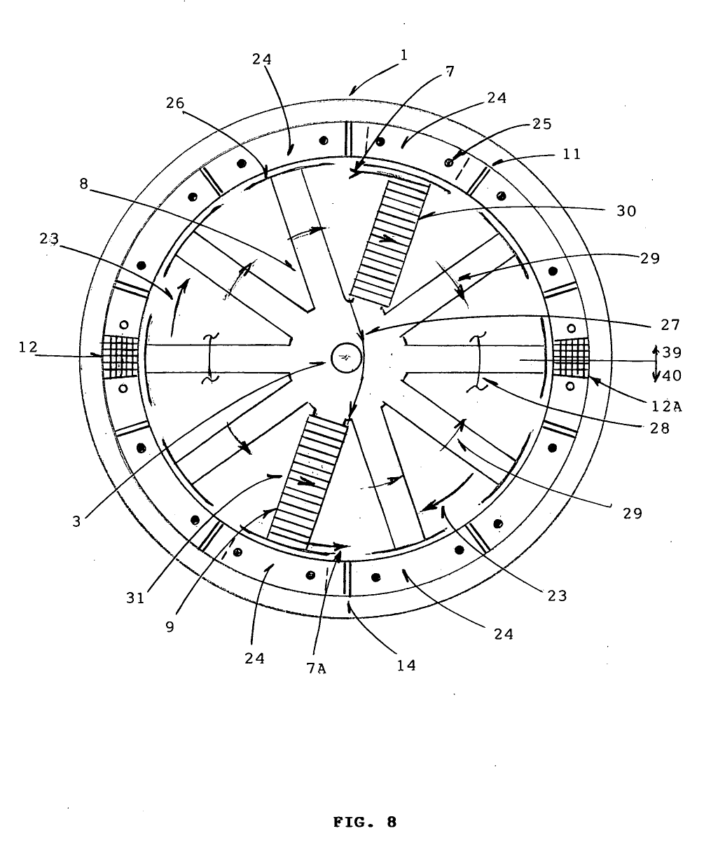

FIG. 8 indicates rotation 23 and field area sweep 24 of both ends of electromagnet 8 and leading edge torque direction 29 of said electromagnet in both halves 39 and 40. Illustrated in FIG. 7 the completing end of coil 9 becomes lead 7a returning parallel with shaft 3 back to the beginning lead 7 of primary coil 6. The two leads 7 and 7a are electrically joined 38 to complete a brushless closed circuit illustrated in FIG. 1 and FIG. 11. There may be as many closed circuits as feasible, in the test model there are five complete closed circuits comprising a star shaped electromagnet 8 shown in FIG. 8.

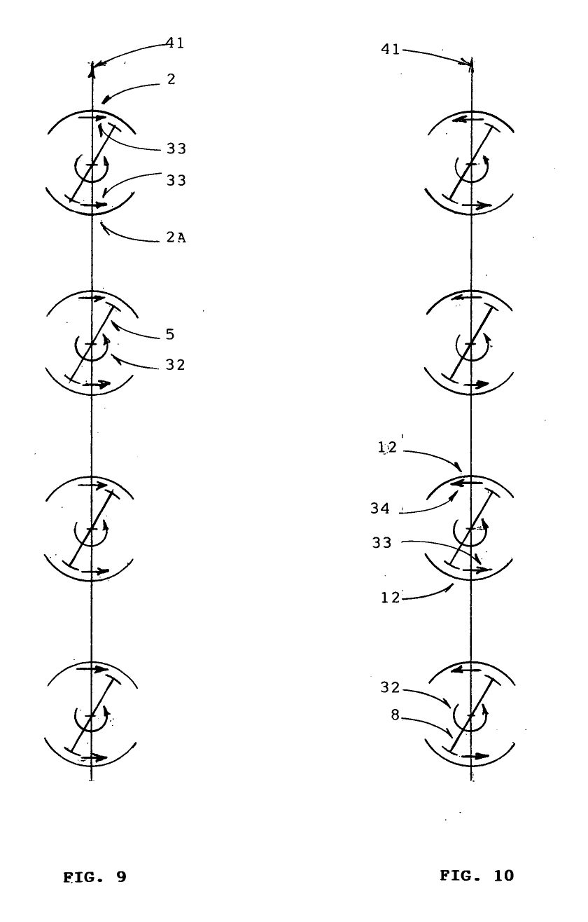

When rotating shaft 3 is energized, primary section 35 induces current flow 7 in closed circuit to solenoid winding 9 section 36 creating a generic magnet with two similar poles. Two similar poles exert two similar torque forces 29 and combined with striking direction create opposite lateral movement forces 41. FIG. 9 illustrates a coil of wire rotating in a standard opposed magnet generator 35 where there is opposite directional movement of the wire in each half cell creating opposite striking direction 32, the reverse striking motion offsets the opposite torque induced force resulting in a prograd 33-prograd 33 relation to the wire which amplifies the magnetic field around the wire. In both cases the lateral force or flow direction 41 is similar.

In the Binary system all generic poles have similar torque inducing forces 29 but there is opposite striking movement. When the moving fields in half 39 are inducing prograd 33 force the other fields in half 40 are inducing retrograd 34 force due to opposite striking direction creating prograd 33-retrograd 34 at the same time nullifying the magnetic effect around the wire. Once again similar lateral forces are induced from each pole causing flow direction 41 in FIG. 10. The core of primary section 35 and solenoid core 8 are affixed to rotating shaft 3 causing opposite striking directions on primary winding 6 and cage winding 25. The half cycle attitudes in areas 21 and 22 in halves 39 and 40 are constantly maintained with the neutral and reversing position 28, best shown in FIG. 4 and FIG. 8 in relation to cage winding 25.

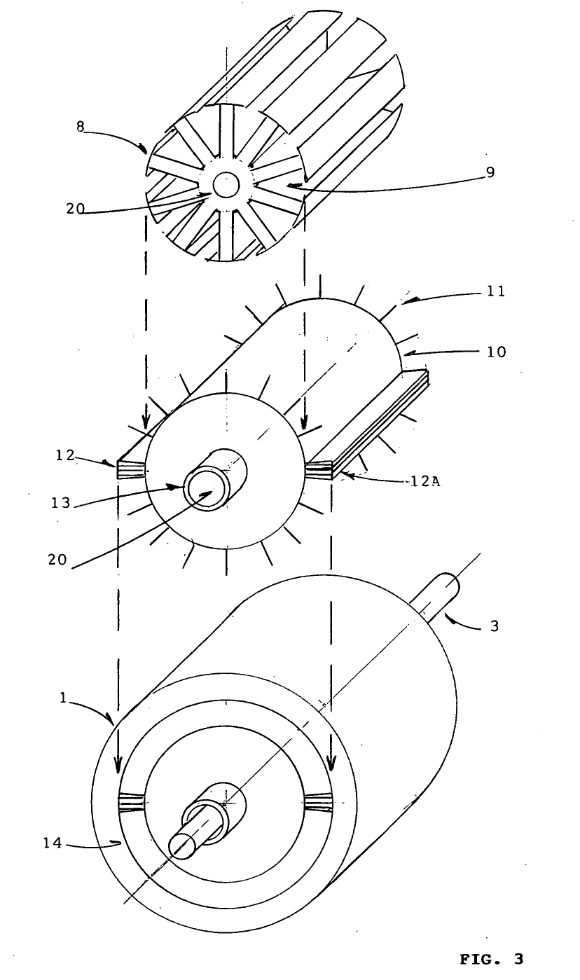

The cage drum 10 best shown in FIG. 3 removed from housing 1 is constructed in two sections of non-magnetic and non-electrical conducting material and assembled over the star magnet 8 maintaining minimum tolerances 26. Centered on the ends of said drum 10 are collars 13 creating openings 20 for shaft 3 and leads 7 and 7a from primary section. 35 and to wrap around external turns for cage winding 25. Positioned around the outer radius of the ends of cage drum 10 are centering and alignment pins 11 to accommodate and align cage winding 25 and to center cage drum 10 on the inner circumference of housing 1.

Shown in FIG. 3 and FIG. 8 are two cage winding 25 spacer blocks 12 which are positioned 180 degrees apart and aligned with gap 2b between opposed magnets 2 and 2a in primary, section 35. The cage winding 25 is then wound on said drum 10. Viewing the cage drum 10 end facing away from primary section 35 the spacer block 12 to the right of shaft 3 is the beginning point of cage winding 25. Shown in FIG. 5 lead 17 is left with future working slack and starts on the left side of spacer block 12, proceeds along said spacer block 12 to the end of cage drum 10 around collar 13 and returns on the opposite side of spacer block 12a being 180 degrees apart.

This is one turn of cage winding 25 and is repeated as many times as feasible being applied in the direction of rotation 23 filling spaces between alignment pins 11 leaving working slack on completion which is lead 16 ending on opposite side of spacer 12 lead 17. Test model contained 700 turns 26 gage. Upon completion of cage winding 25 the Binary unit consisting of sections 35 and 36 affixed to shaft 3 with floating section 37 are inserted into housing 1.

Leads 16 and 17 exiting through opening 15 at this time. Cage winding 25 is bonded to inner surface of housing 1 at area 14 and ends of shaft 3 extend through bearings 4 that are centered in end caps 18.

On completion of sections 35, 36 and 37 without any brushes or contact points rotation 23 is induced to central shaft 3 rotating primary winding 6 and solenoid winding 9. Simultaneously primary winding 6 induces current flow 7 to solenoid winding 9 generating a rotating electromagnet 8 and returning via lead 7a flowing through a closed circuit.

This action takes place each half cycle maintaining the same attitude of the solenoid coils 9 to each half of the cage winding 25 continuously. The sweeping field 22 shown in FIG. 4 induces current flow in cage winding 25 in the same direction continuously in each half 39 and 40 with similar torque inducing properties at all ends of the star electromagnet.

Possible variations apparent to those skilled in the art include but are not limited to the number or size of magnetic cells, number of and configuration of winding notches, gauge of winding wire or number of windings. Also, alternate materials may be used for the shaft, bearings, housing, conductive elements, non-conductive elements, etc., as long as they satisfy the stated objects of each functional element disclosed herein.

The foregoing description of the preferred apparatus and method of installation should be considered as illustrative only, and not limiting. Other techniques or materials may be employed towards similar ends. Various changes and modifications will occur to those skilled in the art, without departing from the true scope of the invention as defined in the above disclosure, and the following claims.

What is claimed is:

1. A continuous current primary stage one comprising an armature comprising at least one pair of opposed notches. Wire coils wound across each pair of said notches but not terminating at each end. Coil leads continuing unbroken to stage two becoming a solenoid coil wound on a solenoid core at 90 degrees to wire coil of stage one that rotates between opposed magnets.

2. Stage one and stage two of claim 1 are affixed to a common shaft supported at each end by bearings in end caps of housing to rotate in unison.

3. Further to claim 2 stage one and stage two coils are physically aligned but wound at right angles to each other in a continuous wire.

4. Closed circuit of claim 3 stage one induces current simultaneously in stage two solenoid coil generating an electromagnet in stage two solenoid coil creating an electromagnet rotating in unison. Further comprising: —similar power flow direction on each half cycle
similar attitude of solenoid on each half cycle

5. Housing of claim 2 shall be constructed of magnetic conductive material and shall be vented as required.

6. Electromagnet of claim 4 is enclosed in a cage drum free of contact with rotating solenoid. Said drum has collared openings centered at both ends to accommodate central shaft and coil leads from stage one to stage two.

7. Cage drum of claim 6 is affixed with centering and coil alignment pins on the exterior of the rim on each end equal to the interior diameter of the housing. Coil spacer blocks are affixed to the exterior of said drum 180 degrees apart each covering 10 degrees of arc.

8. Cage drum of claim 7 is wound with a continuous winding parallel to the central shaft encompassing 170 degrees of equal arc on external opposite halves of said drum terminating on each side of spacer blocks.

9. Completed cage drum and winding of claim 8 encompassing electromagnets and primary stage one are inserted into housing of claim 5 as a single unit.

10. Cage drum and cage winding of claim 9 are bonded to the inner surface of housing, with stage one and stage two supported by central shaft mounted in bearings in housing end caps.

11. Rotating field of claim 4 passes through cage winding of claim 8 in opposite directions on opposite halves of coil inducing continuous current flow.

12. It is further claimed that all operations of claim 4 and claim 11 are completed without brushes or contact friction of any kind between all stages of the Binary generator.
